(19) United States
(12) Patent Application Publication
(10) Pub. No.: US 2011/0309087 A1
(43) Pub. Date: Dec. 22, 2011

(54) APPARATUS FOR DETERMINING A TANK FILL LEVEL, TANK FOR UREA/WATER SOLUTION AND MOTOR VEHICLE HAVING A TANK

(75) Inventors: Jan Hodgson, Troisdorf (DE); Rolf Brück, Bergisch Gladbach (DE); Hermann Ketterl, Stephansposching (DE)

(73) Assignee: EMITEC GESELLSCHAFT FUR EMISSIONSTECHNOLOGIE MBH, LOHMAR (DE)

(21) Appl. No.: 13/184,807

(22) Filed: Jul. 18, 2011

Related U.S. Application Data
(63) Continuation of application No. PCT/EP2010/050267, filed on Jan. 12, 2010.

(30) Foreign Application Priority Data
Jan. 16, 2009 (DE) 10 2009 004 936.3

(51) Int. Cl. B62D 33/00; G01F 23/00

(52) U.S. Cl. 220/562; 220/200; 73/304 R

(57) ABSTRACT

An apparatus for determining a tank fill level includes at least one cap, an extraction pipe which extends through the cap and at least partially has an electrically conductive material, a jacket pipe disposed around the extraction pipe and at least partially has an electrically conductive material, and a measuring unit forming a first electrode with the extraction pipe and a second electrode with the jacket pipe. A tank for a urea/water solution is also provided, in which the apparatus is used as a quality sensor and/or a fill level sensor. A motor vehicle having a tank is also provided.

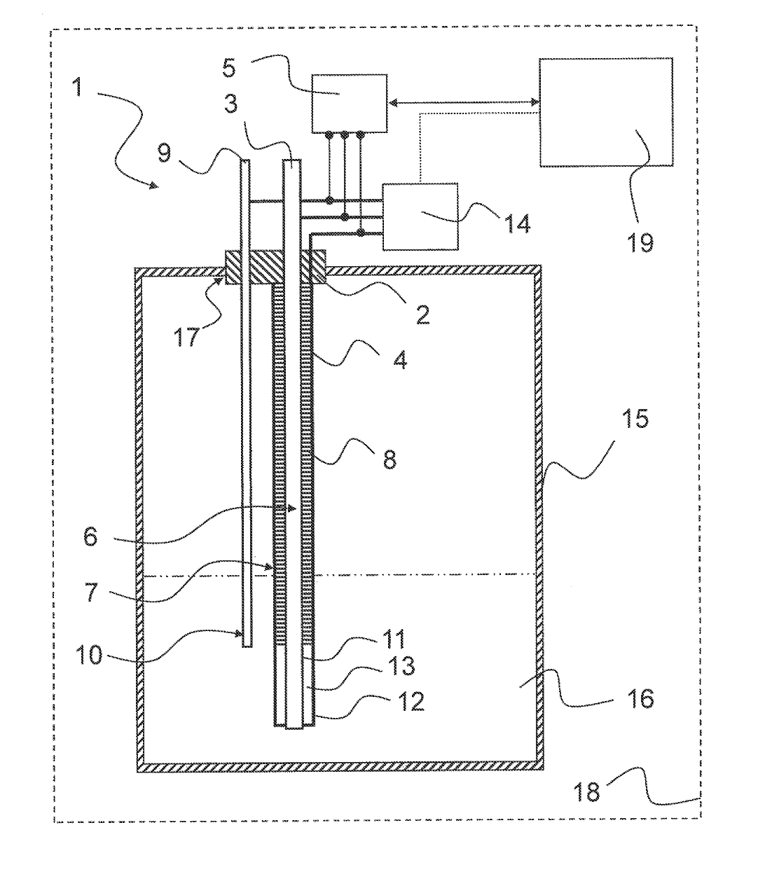

### CROSS-REFERENCE TO RELATED APPLICATION

This is a continuation, under 35 U.S.C. §120, of copending International Application No. PCT/EP2010/050267, filed Jan. 12, 2010, which designated the United States; this application also claims the priority, under 35 U.S.C. §119, of German Patent Application DE 10 2009 004 936.3, filed Jan. 16, 2009; the prior applications are herewith incorporated by reference in their entirety.

### BACKGROUND OF THE INVENTION

### Field of the Invention

The present invention relates to an apparatus for determining a tank fill level and/or a quality of tank contents, in particular for a tank containing a urea/water solution. Since there are numerous applications where a urea/water solution is used to clean exhaust gases from mobile internal combustion engines, the invention relates especially to an apparatus for use in the automotive sector. The invention also relates to a tank for a urea/water solution and a motor vehicle having a tank.

A urea/water solution is used, in particular, in the context of the “SCR process” in the treatment of exhaust gases. The aim of that process is to reduce the nitrogen oxides in the exhaust gas. Ammonia or the ammonia precursor, urea, is often proposed as a reducing agent for that purpose. In that case, the ammonia or urea/water solution is generally added in a manner dependent on the nitrogen oxides to be broken down in the exhaust gas. However, the reducing agent is thus a service fluid, the storage of which requires monitoring. Moreover, it has to be taken into account that the quality of the urea/water solution is also particularly of interest in that case since it is the only way to ensure that the quantity of ammonia required during the operation of internal combustion engines, especially diesel engines, is generated.

Due to future requirements, it may also be necessary to retrofit existing systems with an SCR system. For that purpose, it is necessary for the components of the system to have a compact construction which allows them to be adapted easily to an existing system. A considerable amount of development work is still required to achieve that at the present time. Thus, the known fill level measurement systems and/or quality measurement systems have a complex construction and/or are very sensitive to the dynamic motion of the tank contents during the operation of the motor vehicle.

### SUMMARY OF THE INVENTION

It is accordingly an object of the invention to provide an apparatus for determining a tank fill level, a tank for a urea/water solution and a motor vehicle having a tank, which overcome the hereinafore-mentioned disadvantages and at least partially solve the highlighted problems of the heretofore-known apparatuses, tanks and vehicles of this general type. In particular, the intention is to specify an apparatus for determining a tank fill level which can be produced in a simple and economical manner and requires only a very small amount of installation space.

With the foregoing and other objects in view there is provided, in accordance with the invention, an apparatus for determining a tank fill level. The apparatus comprises:
a cap,
an extraction pipe being extended through the cap and at least partially having an electrically conductive material,
a jacket pipe disposed around the extraction pipe and at least partially having an electrically conductive material, and
a measuring unit forming a first electrode with the extraction pipe and a second electrode with the jacket pipe.

The apparatus described herein is preferably a self-contained component which, in particular, can replace conventional tank closure elements or tank caps. For this purpose, the cap has an appropriate screw thread and/or seal, for example, through the use of which it can be fastened on the tank. The cap furthermore allows the extraction pipe and the jacket pipe to be fixed and aligned in the tank, with the measuring unit being situated on the opposite, outer side, if appropriate. In addition, the cap can, of course, have further components, such as cables, resistance heaters, sensors, connections, adapters, etc.

The extraction pipe is used to extract the tank contents, e.g. a urea/water solution. For this purpose, the extraction pipe is connected to a pump, for example, outside the tank, through the use of which the tank contents are pumped out through the extraction pipe and ultimately added to the exhaust gas. The extraction pipe is preferably made completely of an electrically conductive material, and it should, in particular, also be resistant to the urea/water solution. Suitable materials for the extraction pipe are, in particular, metals that are corrosion resistant to solutions formed of reducing agent precursors (e.g. urea). The use of a stainless steel, an austenitic steel, a chrome-nickel steel and/or a nickel base material is particularly advantageous in this case. In this context, one of the following materials is preferred: No. 1.4301 or No. 1.4828 according to DIN (German Industrial Standard). In this case, a steel with a material number 1.4828 is understood to be a steel that contains no more than 0.2% by weight carbon, 1.5 to 2.5% by weight silicon, no more than 2% by weight manganese, no more than 0.045% by weight phosphorus, no more than 0.03% by weight sulfur, 19 to 21% by weight chrome and 11 to 13% by weight nickel. A steel with a material number 1.4301 is understood to be a steel that contains no more than 0.07% by weight carbon, no more than 1% by weight silicon, no more than 2% by weight manganese, no more than 0.045% by weight phosphorus, 17 to 19.5% by weight chrome, 8 to 10.5% by weight nickel and no more than 0.11% by weight nitrogen. In particular, the material numbers are specified in accordance with DIN EN 10027-2.

In addition, a jacket pipe is now provided around the extraction pipe. The jacket pipe preferably extends over most of the extraction pipe, in particular covering (almost) the entire length of the extraction pipe. The extraction pipe and the jacket pipe are thus disposed concentrically to one another, in particular. Additional components, such as heating elements, can be provided between the extraction pipe and the jacket pipe. The jacket pipe too, like the extraction pipe, must be able to withstand the environmental conditions. It is therefore likewise appropriate in this case to use one of the above-mentioned materials to construct the jacket pipe. It may also be worthwhile to use different materials for each one in this case.

In particular, the measuring unit can also be embodied in the form of a data processing device. It is thus possible in this case for the processing of the electrical signals to be carried out directly in the measuring unit. The measuring unit can likewise contain stored data models which allow analysis or evaluation of the electrical signals. For this purpose, the measuring unit can have appropriate electrical circuits and connections to other components of the apparatus and/or the motor vehicle.

It is now also proposed herein to use the extraction pipe and the jacket pipe as electrodes for capacitive fill level measurement. In order to determine the tank fill level and/or the quality/composition of the tank contents, the first electrode and the second electrode form an electrical capacitor. If the electrodes are situated in an air-filled space, a low initial capacitance can be measured. If the tank fill level is increased, the capacitance increases as the electrodes are increasingly covered. With such capacitive fill level measuring systems, it is possible, in particular, to carry out continuous fill level measurement because the electrical signals detected can be compared with reference data, if appropriate. The measuring unit can also have amplifiers and similar elements, if appropriate, to improve signal evaluation. The electrical resistance, capacitance or comparable variables between the electrodes, for example, can be determined as the electrical variable.

It is thereby possible to make a judgment on the fill level in a particularly simple manner with just the two electrodes on the extraction pipe. In addition, it is also advantageous for the non-conducting region between the two electrodes to have a certain length or height. In other words, this means, for example, that a reserve indicator could be generated by insulating or coating the lower part of the jacket pipe up to a height of about 2 cm. If the fill level falls below this electrically insulated level, conductivity can therefore no longer be measured, which is an indication that the reserve has been reached. When an adequate delivery pressure can no longer be obtained in the feed system for the exhaust system, this shows that the tank is finally empty.

In accordance with another feature of the invention, the extraction pipe and the jacket pipe are connected to each other by an insulating adhesive or a ceramic solder. In this case, the insulating adhesive on one hand performs the function of insulating the jacket pipe and the extraction pipe from one another electrically. In addition, it is also possible in this way, for example, to ensure that the tank contents cannot flow around part, in particular part of the extraction pipe, i.e. that it is also possible to achieve insulation relative to the tank contents in this case. This electrode can therefore also be used as a “reference electrode,” if appropriate. A material which is resistant to urea is preferably used as the insulating adhesive. The properties of such a material are unaffected by urea or a urea solution and, in particular, it is insoluble in a urea solution.

One of the following two methods, in particular, is proposed for soldering metal to ceramic and/or ceramic to ceramic (in which both are referred to herein in common as “ceramic soldering”): a) soldering of metalized ceramic and b) active soldering. In the soldering of metalized ceramic, the joining surface of the ceramic component is coated with a metal, thus enabling the ceramic component of the joint to be wetted in the subsequent soldering process by conventional solders. Active soldering is generally a direct soldering process, in which the active element is added directly to the solder. In this case, the solder should be applied directly to the joining surface because active solders have only slight flowability. The active solder which is preferably used for ceramic soldering is suitable for producing soldered joints between two ceramics or between ceramic and metal. It forms a reactive layer at the solder/ceramic interface, through the use of which the bond can be effected. Due to the composition of the alloy, active solder can wet nonmetallic, inorganic materials. Active solder can at least partially include silver, titanium, copper and/or indium and may be in the form of a eutectic alloy. A solder which is composed of approximately 72% by weight silver and 28% by weight copper and has a melting point of about 780 ° C. is preferred in this case. A solder of this kind can be obtained under the commercial name Lot Degussa 7200 or CuSil, for example. The use of active soldering makes it possible to employ a ceramic material to insulate the extraction pipe and the jacket pipe and, at the same time, to achieve a durable bond that is impermeable to urea solutions.

In accordance with a further feature of the invention, the measuring unit is disposed on the cap. This also means, in other words, that the measuring unit, in particular together with the electronics required for this purpose, is mounted in a protected manner on the outside of the cap. The cap can be embodied with a separate housing that is leak-tight relative to the environment for this purpose.

In accordance with an added feature of the invention, a third electrode is provided in the apparatus. In this case, the third electrode can be formed as a separate unit, e.g. on the tank. However, it is preferred that the apparatus be provided with a return pipe which is disposed adjacent the extraction pipe and forms the third electrode for the measuring unit. The return pipe is used, in particular, to return urea/water solution that has already been extracted from the tank and is in the feed lines leading to the exhaust system back into the tank as required. Therefore, in systems which have such a return, a combination of functions can once again be achieved by using the return pipe as a third electrode. With regard to the materials for such a return pipe, attention is drawn to the statements relating to the extraction pipe and/or the jacket pipe. The construction of the apparatus with three electrodes, in which it is also possible, if appropriate, to embody the third electrode as a separate probe if no return pipe is required, allows not only determination of the fill level but also, if appropriate, determination of the quality of the tank contents, and therefore also allows conclusions to be drawn about the composition of the tank contents, for example. In principle, it is possible, for example, for the first electrode to be used as a reference electrode, for the second electrode to be used as a ground electrode and for the third electrode to be used as a level electrode. In this configuration, the measuring unit is connected to all of the electrodes and, in particular, measurement of the capacitance between different electrodes in each case allows conclusions to be drawn as to the quality and/or fill level. The capacitance and/or resistance of the urea solution can be determined through the use of voltages and currents between the reference electrode and the ground electrode and between the ground electrode and the level electrode, for example. Urea solutions used in the automotive sector generally have a known resistivity and known dielectric properties. It is therefore possible to determine the fill level from capacitances and/or resistances measured between the electrodes through the use of a differential rectifier circuit in the measuring unit.

The resistance (R) between two uninsulated electrodes disposed at a spacing (l) in a tank containing urea solution, have a width (b) and extending perpendicularly over the entire height of the tank, can be obtained approximately by using the following formula as a function of the fill level (h) and the resistivity of the urea solution (ρ), for example:

$$R = ρ \cdot \frac{l}{b \cdot h}$$

As the fill level increases, the resistance between the electrodes thus falls, while a falling fill level entails an increasing resistance. In the case of other, possibly more complex geometrical configurations of the electrodes in the tank relative to one another, a person skilled in the art can devise appropriate formulae for calculating the resistance as a function of the fill level on the basis of the above formula.

In accordance with an additional feature of the invention, it is regarded as advantageous for the first electrode to have a first electrode end section and the second electrode to have a second electrode end section, with the first electrode end section and the second electrode end section forming a free space between them and being connected to a voltage source. The intention in this case, in particular, is that the configuration of the first electrode and of the second electrode should be such that a free space around which the tank contents can flow is created in the end region situated opposite the cap, thus enabling the quality or the composition of the tank contents to be determined, if appropriate. If a voltage is now applied across these two electrodes, the resulting measured values are dependent on the composition of the tank contents in the free space. From this, it is possible to draw conclusions as to the water content and the urea content in the case of a urea/water solution.

In accordance with yet another feature of the invention, it is also possible for the second electrode and a third electrode, which is disposed parallel to the second electrode, to be connected to a voltage source. Of course, the voltage source can be the same for all three electrodes. In this configuration, the second electrode and the third electrode can be used, in particular, to detect the fill level since the tank contents can penetrate into the space between the second electrode and the third electrode, and different voltages can be detected due to the increase in wetting during filling and a decrease in wetting during emptying. For this purpose, it is also proposed that the third electrode end at the level of the tank or change course where the reserve range is reached, for example. In this case, significant changes in the measured value may be detected, and these can be used as a signal for a corresponding indicator.

With the objects of the invention in view, there is also provided a tank for a urea/water solution, comprising an opening for the extraction of the urea/water solution in which, in particular, it is possible to close the opening with the cap of the apparatus described herein in accordance with the invention. The compact, functional and modular apparatus having a simple construction can therefore now also be part of a tank system.

With the objects of the invention in view, there is concomitantly provided a motor vehicle, comprising the above-mentioned tank and a controller which is connected to the measuring unit. The controller can be the engine management system of the motor vehicle, for example, and this system is also set up for the addition of urea/water solution to the exhaust system of the motor vehicle as required. This is done precisely for the purpose described at the outset of implementing an SCR system.

Other features which are considered as characteristic for the invention are set forth in the appended claims, noting that the features presented individually in the claims can be combined with one another in any technologically feasible manner and give rise to further embodiments of the invention.

Although the invention is illustrated and described herein as embodied in an apparatus for determining a tank fill level, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a diagrammatic, cross-sectional view of a tank and an apparatus according to the invention in a motor vehicle.

### DETAILED DESCRIPTION OF THE INVENTION

Referring now in detail to the single FIGURE of the drawing for explaining the invention and the technical field in more detail by showing a particularly preferred structural variant to which the invention is not restricted, there is seen a diagrammatic cross section through a tank 15 having an apparatus 1 according to the invention. In this case, the tank 15 is a storage vessel for a urea/water solution 16. This tank 15 is furthermore part of a motor vehicle 18, which is indicated diagrammatically in the FIGURE.

An upper region of the tank 15 has a wall with an opening 17 formed therein, into which a cap 2 is inserted as a closure for the tank 15. The tank 15 and the cap 2 are preferably manufactured from plastic, e.g. polyethylene.

In this configuration, the cap 2 is penetrated by two pipes, namely an extraction pipe 3 for the extraction of the urea/water solution 16 from the tank 15 and a return pipe 9, through which urea/water solution 16 which has been extracted but is not required can be directed back into the tank 15. Furthermore, a jacket pipe 4, which is formed on a side of the cap 2 facing the interior of the tank, surrounds the extraction pipe 3 substantially completely in the interior of the tank 15. At the same time, the jacket pipe 4 is disposed at a spacing relative to the extraction pipe 3. An electrically insulating adhesive 8 is provided in an upper region, between the extraction pipe 3 and the jacket pipe 4. The adhesive fixes a position of the extraction pipe 3 relative to the jacket pipe 4 and insulates components electrically from one another in a reliable manner in that section.

Moreover, a measuring unit 5 which is, in particular, positioned on the outside of the cap 2, and a voltage source 14, are provided. The measuring unit 5 and the voltage source 14 are both connected to the extraction pipe 3, the jacket pipe 4 and the return pipe 9 in such a way that the extraction pipe 3 acts as a first electrode 6, the jacket pipe 4 acts as a second electrode 7 and the extraction pipe 9 acts as a third electrode 10. In this case, a fill level can be detected between the third electrode 10 and the second electrode 7 over a large range of variation of the fill level of the urea/water solution, for example. Moreover, the first electrode 6 and the second electrode 7 have a first electrode end section 11 and a second electrode end section 12 on a side facing away from the cap 2. These electrode end sections 11, 12 in this case jointly form an annular free space 13. This region with the electrode end sections can additionally be provided with a concentric shield, if appropriate, in order to counteract fluctuations in flow and the like, for example. In this configuration, the urea/water solution 16 can penetrate into the free space 13, and information on the quality of the urea/water solution can be obtained in this case by using a constant length of the electrode end sections and a measurement.

The type of measurement, the time of measurement and/or the evaluation of the measurement can also be initiated or performed through the use of a controller 19 of the motor vehicle 18, if appropriate. The controller 19 is therefore, in particular, in a data exchange relationship with the measuring unit 5 and/or operates the voltage source 14 for the measurements as required.

1. An apparatus for determining a tank fill level, the apparatus comprising:
a cap;
an extraction pipe being extended through said cap and at least partially having an electrically conductive material;
a jacket pipe disposed around said extraction pipe and at least partially having an electrically conductive material; and
a measuring unit forming a first electrode with said extraction pipe and a second electrode with said jacket pipe.

2. The apparatus according to claim 1, which further comprises an insulating adhesive or a ceramic solder connecting said extraction pipe and said jacket pipe to each other.

3. The apparatus according to claim 1, wherein said measuring unit is disposed on said cap.

4. The apparatus according to claim 1, which further comprises a third electrode for said measuring unit.

5. The apparatus according to claim 1, which further comprises a return pipe disposed adjacent said extraction pipe and forming a third electrode for said measuring unit.

6. The apparatus according to claim 1, which further comprises a voltage source, said first electrode having a first electrode end section, said second electrode having a second electrode end section, said first electrode end section and said second electrode end section forming a free space therebetween, and said first electrode end section and said second electrode end section being connected to said voltage source.

7. The apparatus according to claim 1, which further comprises a third electrode disposed parallel to said second electrode, and a voltage source connected to said second electrode and said third electrode.

8. A tank for a urea/water solution, the tank comprising:
a wall having an opening formed therein for extraction of the urea/water solution; and
said apparatus according to claim 1, said cap of said apparatus configured for closing said opening.

9. A motor vehicle, comprising:
a tank for a urea/water solution, said tank including a wall having an opening formed therein for extraction of the urea/water solution and said tank including said apparatus according to claim 1, said cap of said apparatus being configured for closing said opening; and
a controller connected to said measuring unit.
